(19) United States
(12) Patent Application Publication
(10) Pub. No.: US 2008/0279067 A1
(43) Pub. Date: Nov. 13, 2008

(54) Optical Record Carrier Comprising An Indiction Area for Indicating Whether A Recordable Area Is Fully Recorded, And Devices For Use With Such Record Carrier

(75) Inventors: Johannes Gerardus Fredericus Kablau, Eindhoven (NL); Josephus Bernardus Maria Segers, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/091,081

(22) PCT Filed: Oct. 17, 2006
(86) PCT No.: PCT/IB06/53809

§ 371 Date: Apr. 22, 2008

(30) Foreign Application Priority Data
Oct. 27, 2005 (EP) 05110097.2

(51) Int. Cl. G11B 5/58; G11B 7/24

(52) U.S. Cl. 369/53.2; 369/275.3

(57) ABSTRACT

The inventions relates to an optical record carrier (1) comprising a first area (2) comprising embossed structures representing pre-recorded system information, and a second area (3) intended for recording information, said first area located at the inner radius of the record carrier with respect to said second area and comprising an embossed structure (4) indicative of the type of the record carrier. The record carrier further comprises an indication area (5) located in said second area and adjacent to said first area, which indication area intended for indicating whether the second area is considered to be fully recorded, or is to be considered to be blank or partially recorded. The invention further relates to a read device and a recording device for use with the record carrier according to the invention.

The invention is related to an optical record carrier comprising a first area comprising embossed structures representing pre-recorded system information, and a second area intended for recording information, said first area located at the inner radius of the record carrier with respect to said second area and comprising an embossed structure indicative of the type of the record carrier. The invention is further related to an optical read device for reading such an optical record carrier, and to an optical recording device for recording information on such an optical record carrier.

An optical record carrier as described in the opening paragraph is well known in recordable (R) and rewritable (RW) optical recording systems (such as, for example, CD, DVD and BD). Such a record carrier is made up of an optical stack. This stack commonly consists of a polycarbonate substrate, at least one sensitive dye layer or phase change layer, a gold or silver alloy reflector and a protective lacquer coating.

Information is recorded to the second area of the record carrier by focusing a high power radiation beam, such as a laser beam, onto the dye layer or phase change layer so as to heat an area such that the reflectivity of this area is altered. These altered areas, referred to as marks, generally form a spiral track of variable length marks and of lands (areas between the marks). The resulting pattern of the marks and lands encodes the data recorded on the record carrier.

In order to access such a record carrier (that is, read information from, or record information to the optical record carrier), optical read devices and/or optical recording devices generally require some system information quantifying the record carrier. Such system information includes, for example, an indication of the manufacturer and of the type of the optical record carrier. This record carrier related system information is generally stored on the optical record carrier itself, and is often referred to as Disc Information (DI). For this purpose a first area is provide on the optical record carrier in which the system information (Disc Information) is pre-recorded in the form of non-erasable embossed structures. Generally, this is in the form of embossed marks. It is noted that the record carrier related system information may be encoded in patterns of variable length marks and lands. Alternatively, the record carrier related system information may be encoded in the radial modulation of a sequence of pre-recorded marks (that is, in the modulation of a periodical sinusoidal deviation of the marks in such sequence from their average centreline), or even in the high frequency radial modulation (HFM) of an embossed groove as is the case in record carriers according to the Blu-ray Disc (BD) specifications. In the following the invention will be explained with reference to pre-recorded marks indicative of the type of the record carrier. It is, however, to be noted that any of the alternative embossed structures mentioned above may replace such pre-recorded marks without deviating from the invention.

This first area comprising system information is generally located at the inner radius of the record carrier. This allows an optical read device, which normally starts reading the record carrier at its inner radius, to first access the system information (Disc Information) in the first area before continuing to read the information recorded in the second area.

Known recordable and rewritable optical record carriers according to the Blu-ray Disc (BD) standard generally comprise a Phase change layer or an alloy (such as, for example, Cu/Si) type layer having a relatively low reflectivity. These record carriers result in a relatively low Push Pull signal when accessing the record carrier. The Push Pull signal is a well know control signal used when following the spiral track of marks (see, for example, Principles of Optical Disc Systems, Bouwhuis et. al., Adam Hilger Ltd).

Recently also Blu-ray Disc media having a dye layer have been introduced. Dye type media are well known for CD-R and DVD±R. Especially, the, so-called, in-groove type dye media appear to have excellent recording properties. In contrast to the known dye media (that is, the on-groove type), these in-groove type media have a Low-to-High mark polarity. In order to distinguish these in-groove type media from on-groove type media an area identifying the polarity of the record carrier (either, High-to-Low or Low-to-High) has been introduced in the first area comprising system information (Disc Information).

However, it is a problem of these in-groove type dye media (having a Low-to-High mark polarity) that they result in a relatively high Push Pull signal when accessing unrecorded areas of the second area (see, not pre-published European Patent Application 05103838.8; PH000888). As a result, these in-groove type dye media may be both read- and write incompatible, especially with first generation BD drives.

It is an object of the present invention to provide an optical record carrier as described in the opening paragraph of the in-groove dye layer type that are read- and write compatible with existing optical read and/or optical write devices. It is a further object to provide an optical read device and an optical recording device for accessing such an optical record carrier according to the invention. It is an even further object of the invention to provide read software and recording software intended to be installed in existing optical read and/or recording devices such that they become operative for accessing the optical record carrier according to the invention.

According to a first aspect of the invention this object is achieved by providing an optical record carrier according to the preamble further comprising an indication area located in the second area and adjacent to the first area, said indication area intended for indicating whether the second area is considered to be fully recorded, or is to be considered to be blank or partially recorded. It was recognized by the inventors that the Push Pull signal of areas in the second area intended for recording information decreases to a conventional level when information (that is, marks) is recorded in these areas. Read compatibility of BD record carriers that have a continuous recorded second area is now achieved by indicating this in the indication area. This indication area is always accessible by a read and/or recording device, irrespective of whether or not the second area is fully recorded, because it is located adjacent to the first area having a normal Push Pull signal level. The proximity of the first area enables accessing the indication area by simply tracking the groove for a limited distance (and, therefore, limited amount of time) rather than jumping from the first area to the indication area over a number of grooves in the second area. Such a tracking of the groove is relatively safe compared to jumping over grooves from an optical feed trough point of view because the magnitude of the radial error signal (that is, the Push Pull signal) remains relatively low.

By using an optical record carrier according to the invention it becomes feasible to

distinguish media having a Low-to-High mark polarity (that is, in-groove type media) from other media by reading the pre-recorded marks indicative of the type of the record carrier in the first area,

for such media determine, based on the status of the indication area, whether the second area is such that a single continuously recorded area remains (that is, considered fully recorded), and

subsequently read the information recorded in the second area when the second area is considered to be fully recorded, or discontinue reading when the second area is considered to be blank or partially recorded.

In a preferred embodiment the indication area has marks recorded when the second area is considered to be fully recorded, and has no marks recorded when the second area is considered to be blank or partially recorded. Now, the status of the indication area can simply be determined by the presence or the absence of a High Frequency (HF) signal. This embodiment is robust since no sequences of marks and lands needs to be decoded to retrieve information regarding the status of the second area, which decoding may be inaccurate when marks of low quality are recorded in the indication area.

In an embodiment of the record carrier according to the invention there is provided a transition area in between the first area and the indication area located in the second area. This transition area is reserved because of mastering transition effects (that is, undesirable effects caused by the transition from a pre-recorded (embossed) area to a recordable area on the record carrier). The pre-recorded first area (in BD systems referred to as PIC band) may be mastered under specific conditions in order to reduce the Push Pull signal level and, generally, has a higher track pitch than the recordable second area in which the indication area is located. Therefore, it is preferred to have a transition area to ensure good recordability. In a further embodiment this transition area is an unrecorded area with a preferred width in the range of 6 μm to 16 μm, which should be sufficient to change the mastering conditions from the first area conditions to the second area conditions. When the width of the transition area is chosen within the above range it is assured that the width is large enough to change the mastering conditions from the first area conditions to the second area condition, and is small enough so as not to cause an additional start-up time (caused by scanning over the transition area) which is prohibitively large.

According to a second aspect of the invention there is provided an optical read device operative for reading the pre-recorded marks indicative of the type of the record carrier, deciding, based on the pre-recorded marks indicative of the type of the record carrier, whether the record carrier is of a first type, scanning the indication area when the record carrier is of said first type, and for deciding based on the indication area whether the second area is to be considered to be fully recorded, or is to be considered to be blank or partially recorded. Such a read device is able to read the information recorded in the second area of an in-groove type dye media when this second area is fully recorded.

According to a third aspect of the invention there is provided an optical recording device operative for deciding whether the second area is to be considered to be fully recorded, or is to be considered to be blank or partially recorded, and for recording marks in the indication area when the second area is considered to be fully recorded. Such a recording device is capable of providing an indication in the indication area on the record carrier when the second area is fully recorded.

According to even further aspects of the invention there is provided software that can be loaded into existing optical read and/or recording devices (a so-called firmware update) such that they become operative for accessing the optical record carrier according to the invention. Such software may be provided on any type of record carrier, such as, for example, a CD-ROM of DVD-ROM disc.

It is noted that although the invention is described with reference to Blu-ray Disc record carriers, the invention can equally well and without departing from the inventive concept be used in other types of record carriers, Moreover, the invention is not restricted to single layer record carrier only, but can equally well be used in record carriers consisting of two or more layers for recording the information.

In the following the invention will be elucidated in greater detail and with reference to the accompanying figures, in which

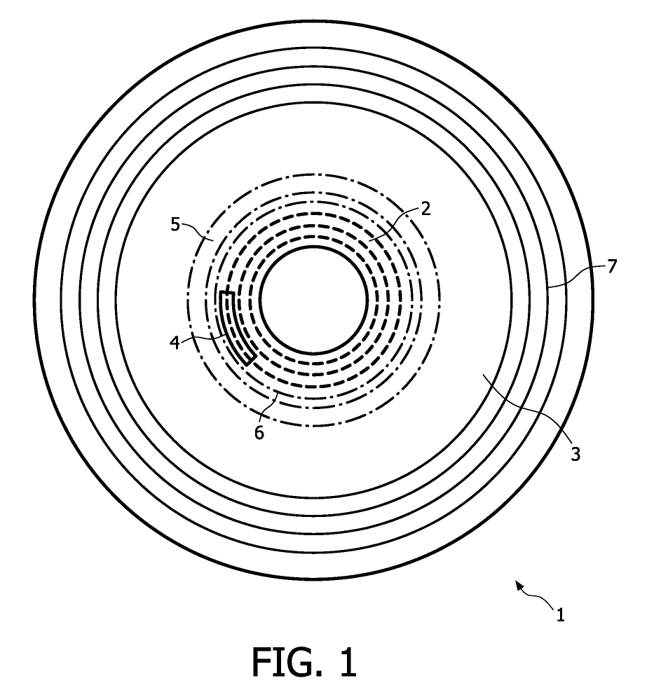

FIG. 1 shows a record carrier according to an embodiment of the invention,

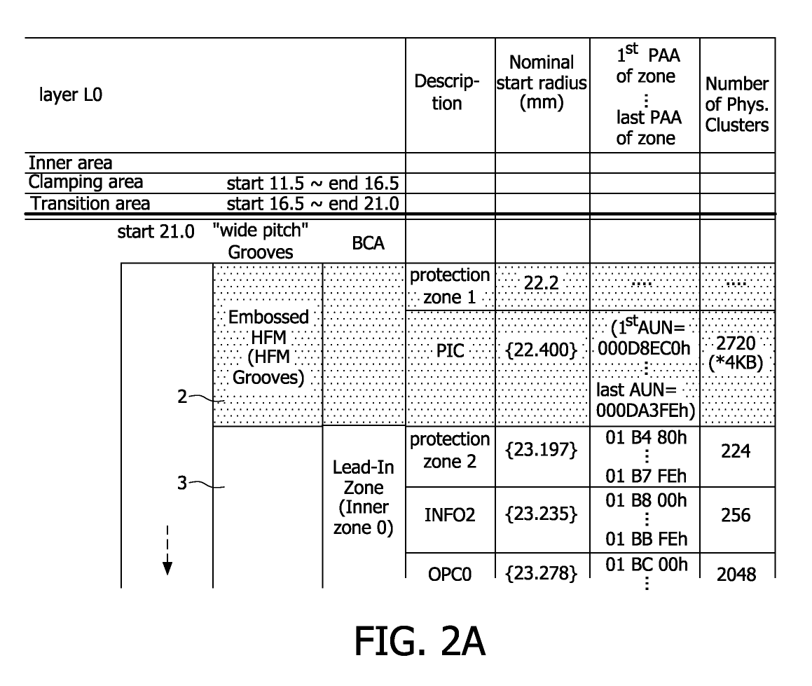

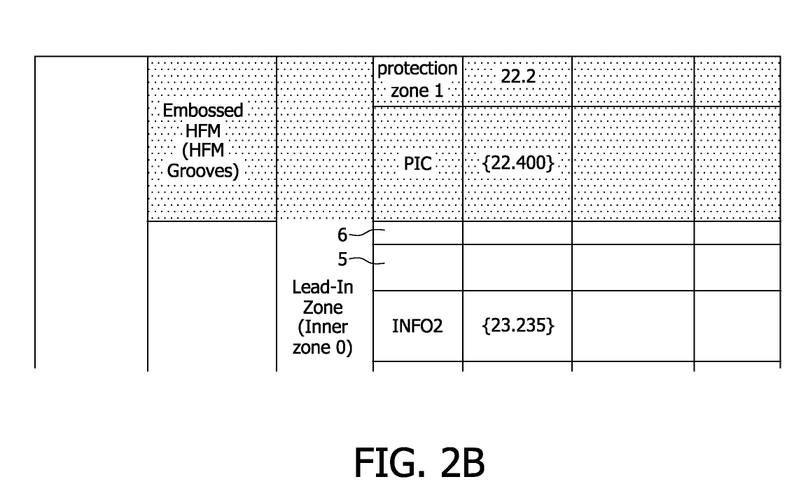

FIG. 2A shows the logical layout of a prior art record carrier and

FIG. 2B shows the logical layout of a record carrier according to the invention, and

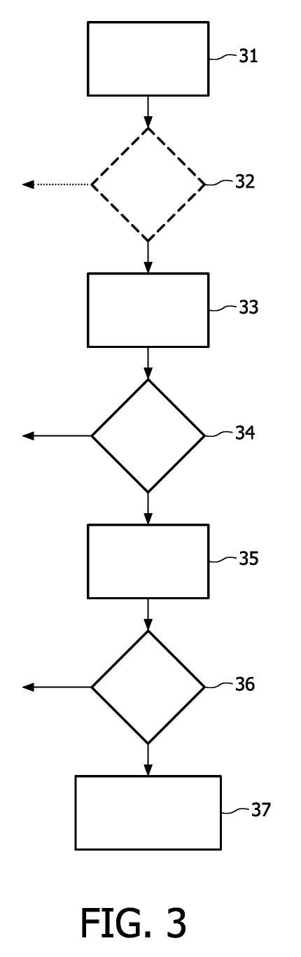

FIG. 3 shows the process steps in an embodiment of a read device according to the invention.

The information recorded on an optical record carrier is in general arranged along tracks. A track on a disc-shaped optical record carrier is a 360 degrees turn of a continuous spiral line or a circular line on such disc. A track may comprise a groove and/or a land portion between grooves. A groove is a trench-like feature in the recording layer, separated from neighboring grooves by land portions of the recording layer, the bottom of the trench being nearer to or further away from the side of the record carrier on which a radiation beam, such as a laser beam, impinges for scanning it. Information may be recorded on the lands and/or in the grooves in the form of optically detectable marks.

In a record carrier having a dye layer the recording process is more optimal when the dye volume in which the data are recorded is confined within the grooves present on the surface of the substrate. In case of on-groove type media (such as present CD-R and DVD+R discs) the grooved sections that confine the dye are pointing towards the radiation entry surface of the record carrier. In the case of the recently introduced BD media of the in-groove type, the grooves are pointing away from the radiation entry surface (in this case the land sections, which are in between the grooves, are pointing towards the radiation entry surface). It is noted that radial tracking is dependent on the type of disc (that is, on-groove tracking versus in-groove tracking).

Information is recorded to the second area of the record carrier by focusing a high power radiation beam, such as a laser beam, onto the dye layer so as to heat an area such that the reflectivity of this area is altered. The information to be recorded is now encoded into sequences of these altered areas, referred to as marks, and of lands (unaltered areas between the marks). Conventionally the marks are areas having a low reflectivity with respect to the surrounding lands, resulting in a so-called High-to-Low mark polarity. In contrast, the recently introduced BD media of the in-groove type have a Low-to-High mark polarity; the reflectivity of such a mark is higher that the reflectivity of its surrounding lands.

The radial position of the radiation spot for scanning the record carrier relative to the groove is detected by means of the so-called Push-Pull (or differential) method. This radial tracking method employs at least two radiation-sensitive detector-segments arranged in the path of the radiation beam that has been reflected from the optical record carrier so that the detector-segments receive radially different portions of the reflected radiation beam. The difference between the output signals of the two detector-segments contains information about the radial position of the radiation spot relative to the groove. If the output signals are equal, the center of the radiation spot coincides with the center of the groove, or with the center between two adjacent grooves. The push-pull signal may be calculated with scalar diffraction calculations as published in “Principles of Optical Disc Systems” (Bouwhuis et. al., Adam Hilger Ltd). Generally the Push-Pull signal is derived by subtracting the signals from the right I₁ and left detector segment I₂ of a split detector which is present in the path of the reflected radiation beam, such as a laser beam, during scanning of the tracks. Generally, the Push-Pull signal is defined as a normalized parameter PPN=<I₁−I₂>/[I₁+I₂] (where, <I₁−I₂>denotes the maximum difference of I₁−I₂, and [I₁+I₂] denotes the average value of I₁+I₂).

In the case of the recently introduced BD media of the in-groove type (having a Low-to-High mark polarity) having a dye layer, the PPN signal resulting from an unrecorded area (also referred to as blank area) is very high; up to 3 times the level of inorganic BD media. Drives operating with conventional astigmatic focusing methods suffer from high optical feed through. As a result the focus servo will suffer from unacceptably high focus error signals, especially during a track jump. This will jeopardize the robustness of the focus system and will cause dissipation in the focus actuator, possibly to the point where the focus coil may be burnt. The PPN signal reduces significantly after information (that is, sequences of marks and lands) is recorded in the dye layer. This reduction may be by a factor of 2 or more. Such a reduced PPN now enables tracking on these recorded areas.

It is now expected that BD dye disc development will focus on 2nd generation drives that have more advanced ways of dealing with optical feed through. This would lead to a new generation of media that lack compatibility with the 1^{st} generation drives, not only for writing but also especially for reading. The latter is considered very serious: it would not only create confusion at the user side but could lead to damaged drives (for example, burnt focus coils due to optical feed through when unrecorded areas of in-groove type media having a dye layer are read by 1^{st} generation drives). The current invention allows for these dye type discs to be used in 1^{st} generation drives, without causing damage to these drives.

FIG. 1 shows an embodiment of a disc shaped optical record carrier 1 according to the invention. This record carrier 1 comprises at its inner radius an area 2 consisting of embossed marks and of lands between the embossed marks. These embossed marks and lands represent system information that is pre-recorded on the record carrier.

The record carrier 1 further comprises a second area 3 intended for recording information. Information is recorded in this area 3 by focusing a high power radiation beam, such as a laser beam, onto the dye layer of the record carrier. In this way variable length marks are formed having a higher reflectivity than the surrounding land. A mark having a higher reflectivity than its surrounding land is often referred to as Low-to-High mark. In contrast, current record carriers are generally of the type where a mark has a lower reflectivity than the surrounding land. Such a mark having a lower reflectivity than its surrounding land is often referred to as High-to-Low mark. Information regarding the type of record carrier (either Low-to-High or High-to-Low) is encoded in a sequence of pre-recorded marks 4 located in the area 2 consisting of embossed marks.

The marks representing the recorded information are arranged along tracks 7. FIG. 1 shows only a few of these tracks 7 at a strongly enlarged scale. In fact the entire second area 3 is covered with tracks 7 which are, for example, spaced apart by 0.32 μm. Moreover, FIG. 1 shows the tracks as circular lines on a record carrier 1, whereas tracks formed by a 360 degrees turn of a continuous spiral line are alternatively possible (for example in BD discs). Physically the tracks are formed by the grooves.

According to the invention, the record carrier 1 comprises an indication area 5. This indication area 5 is located in the second area 3 intended for recording information and is as close as possible to the area 2 consisting of embossed marks. Such an indication area 5 would normally be located in the so-called Lead-In zone of optical record carriers.

The indication area 5 is intended for indicating whether the second area 3 is considered to be fully recorded, or is to be considered to be blank or partially recorded. In this context fully recorded includes a single continuously recorded area. In a preferred embodiment this indication area 5 has marks recorded in it when the second area is considered to be fully recorded, and has no marks recorded in when the second area is considered to be blank or partially recorded. Since the status of the second area is indicated by the mere presence of absence of marks, and these marks do not represent any data, the requirements on the quality of the marks recorded in the indication area 5 is relatively mild.

In an embodiment of the record carrier 1 a transition area 6 is provided in between the area 2 consisting of embossed marks and the indication area 5. This area allows for the transition between the embossed area 2 and the recordable area 3 and has a width sufficiently to change the mastering conditions from the first (embossed) area conditions to the second (recordable) area conditions. A good value for this width is in arrange from 6 μm to 16 μm, or in the range of approximately 18 to 50 continuous track widths.

FIG. 2A shows schematically the logical layout of a prior art record carrier as defined in the Blu-ray Disc standard. The first embossed area 2 ranges from a inner radius of 22.2 mm up to a radius of 23.197 mm. The second recordable area 3 start from a radius of 23.197 mm with the so-called Lead-In zone. In this Lead-In zone predefined areas are reserved for specific purposes; such as, for example, the INFO2 area for recording system and/or disc related information, and the OPC0 area used for recording marks during an Optimum Power Calibration procedure. An area referred to as “protection zone 2” is reserved for the transition between an embossed area and a recordable area.

FIG. 2B shows the logical layout of a record carrier according to the invention. According to an embodiment of the invention the “protection zone 2” in the prior art record carrier has been replaced by the transition area 6 and the indication area 5. According to a further embodiment of the invention the transition area 6 (being 10 μm in width) ranges from a radius of 23.197 mm to a radius of 23.207 mm, and the adjacent indication area 5 ranges from a radius of 23.207 mm to a radius of 23.235 mm.

FIG. 3 shows the steps in an embodiment of a read device according to the invention for use with the record carrier according to the invention as described above. In a

first initial step 31 the read device tries to get in focus at the radial location of the first area 2. In a next

optional step 32 the read device decides whether the mounted record carrier 1 is a BD, a DVD, or a CD disc (this step is only proved when the read device supports record carriers according to at least two of these optical standards). In case of a BD record carrier,

pre-recorded marks 4 indicative of the type of the record carrier are read from the first area 2 in a read step 33. It is noted that according to the BD standard the type of the record carrier is alternatively encoded in the high frequency radial modulation (HFM) of an embossed groove. In a next

decision step 34 it is decided, based on the pre-recorded marks 4 indicative of the type of the record carrier, whether or not the record carrier is of the type having Low-to-High mark polarity. It is noted that according to the BD standard a Low-to-High disc (or layer for storing the information) can be identified by a mark polarity flag; moreover, Low-to-High dye discs can be identified by a class number indicating a disc from a non compatible standard extension. When the record carrier is of the Low-to-High type, the device continues to follow the track formed by the embossed marks in the first area 2 (or the high frequency radial modulation (HFM) embossed groove) into the start of the second recordable area 2. From a certain position into the second recordable area 2 the device performs a

scanning step 35 for detecting the presence or the absence of a High Frequency (HF) signal when scanning the indication area 5. This certain position into the second recordable area 2 should be such that it is not in the transition area 6, but in the is indication area 5. For example, when the width of the transition area 6 is about 32 times the track width (that is 10 μm at a track width according to the BD specification of 0.32 μm), 35 tracks could be skipped after the start of the second recordable area 2 before scanning the indication area 5. It should be noted that the term “skipped” in this context does not include “jumping over” but rather “scanning along”. In a next

decision step 36 it is decided that the record carrier is closed (that is, fully recorded) when a HF signal is detected. When the record carrier is considered closed information in the remainder of the second recordable may be read-out 37 safely.

The above steps in a read device according to the invention may be implemented by means of hardware comprising several distinct elements. However, several steps may be embodied by one and the same item of hardware. Moreover, some steps, or combination of steps, may be implemented by means of a suitably programmed processor.

1. Optical record carrier (1) comprising
a first area (2) comprising embossed structures representing pre-recorded system information, and
a second area (3) intended for recording information,
said first area located at the inner radius of the record carrier with respect to said second area and comprising an embossed structure (4) indicative of the type of the record carrier,
characterized in that the optical record carrier further comprises
an indication area (5) located in said second area and adjacent to said first area,
said indication area intended for indicating whether the second area is considered to be fully recorded, or is to be considered to be blank or partially recorded.

2. Optical record carrier as claimed in claim 1, wherein said indication area has marks recorded when the second area is considered to be fully recorded, and has no marks recorded when the second area is considered to be blank or partially recorded.

3. Optical record carrier as claimed in claim 1, further comprising a transition area (6) in between the first area and the indication area located in the second area.

4. Optical read device for reading an optical record carrier (1) as claimed in claim 1, the read device operative for
reading (33) the embossed structure (4) indicative of the type of the record carrier,
deciding (34), based on the embossed structure indicative of the type of the record carrier, whether the record carrier is of a first type,
scanning (35) the indication area (5) when the record carrier is of said first type, and for
deciding (36) based on the indication area whether the second area (3) is to be considered to be fully recorded, or is to be considered to be blank or partially recorded.

5. Optical read device as claimed in claim 4, further operative for reading (37) the information recorded in the second area when the second area is to be considered to be fully recorded, and for discontinuing reading when the second area is to be considered to be blank or partially recorded.

6. Optical read device as claimed in claim 4, wherein the record carrier is considered to be of the first type when the reflectivity of recorded marks is higher that the reflectivity of land (Low-to-High mark polarity).

7. Optical read device as claimed in claim 4, wherein the read device is operative for deciding that second area is to be considered to be fully recorded when a High Frequency (HF) signal is detected when scanning the indication area, and is operative for deciding that second area is to be considered to be blank or partially recorded when a High Frequency (HF) signal is not detected when scanning the indication area.

8. Optical recording device for recording on an optical record carrier (1) as claimed in claim 1, the recording device operative for
deciding whether the second area (2) is to be considered to be fully recorded, or is to be considered to be blank or partially recorded, and for
recording marks in the indication area (5) when the second area is considered to be fully recorded.

9. Read software intended to be installed in an optical read device such that the read device becomes operative for
reading the embossed structure indicative of the type of the record carrier,
deciding, based on the embossed structure indicative of the type of the record carrier, whether the record carrier is of a first type,
scanning the indication area when the record carrier is of said first type, and for
deciding based on the indication area whether the second area is to be considered to be fully recorded, or is to be considered to be blank or partially recorded.

10. Recording software intended to be installed in an optical recording device such that the recording device becomes operative for
deciding whether the second area is to be considered to be fully recorded, or is to be considered to be blank or partially recorded, and for
recording marks in the indication area when the second area is considered to be fully recorded.
